(19) United States
(12) Patent Application Publication
(10) Pub. No.: US 2004/0203307 A1
(43) Pub. Date: Oct. 14, 2004

(54) Wallcovering for use on irregular surfaces

(76) Inventors: Francis J. Babineau JR., Parker, CO (US); Donald R. Steinle, Littleton, CO (US); Glenda Beth Bennett, Toledo, OH (US); Alan Michael Jaffee, Bowling Green, OH (US)

Correspondence Address: Robert D. Touslee, Johns Manville, 10100 West Ute Avenue, Littleton, CO, 80127, US

(21) Appl. No.: 10/412,437

(22) Filed: Apr. 11, 2003

(51) Int. Cl. B32B 17/02; B32B 17/04; B32B 5/26; D04H 5/00; D04H 1/00; D04H 13/00; D04H 3/00; B32B 3/28; B32B 3/30

(52) U.S. Cl. 442/268; 442/331; 442/180; 442/348

(57) ABSTRACT

A wallcovering system, composite wallcovering and method for providing a smooth finished surface to wall substrate are provided. The wallcovering system comprises a composite wallcovering consisting essentially of a decorative wallcovering layer bonded to a base sheet having sufficient stiffness, thickness and compressibility to conceal surface irregularities on a wall surface of a wall substrate. In one aspect of the invention, the composite wallcovering comprises a layer of woven glass fiber adhesively bonded to a nonwoven fiber glass mat. The composite wallcovering can be installed in one step to provide a smooth finished wall surface on the wall substrate.

### BACKGROUND OF THE INVENTION

1. Field of the Invention

The subject invention pertains to wallcoverings. In particular, the subject invention relates to wallcoverings combined with fiber glass mat materials for use on walls with surface irregularities so as to conceal the irregularities and to provide an aesthetically pleasing surface in a single application.

2. Description of Related Art

Current methods for providing a smooth finish to irregular wall surfaces include plaster or tape and joint compound for paneling, unfinished gypsum board or concrete (poured or block) walls. Another option for paneling or concrete walls is to use furring strips (thin wood slats) and gypsum wallboard. These methods tend to be relatively expensive, time-consuming, potentially messy and require a certain amount of skill to complete. Furthermore, furring out an additional layer of gypsum wallboard may increase the wall thickness by an unacceptable amount.

Other methods of covering wall surface irregularities have also been proposed. U.S. Pat. No. 5,605,259 relates to a method and apparatus for covering irregularities in a wall surface involving applying drywall compound which is formulated to be flowable and placed into an aerosol container with a propellant material.

U.S. Pat. No. 5,820,958 describes providing a patch for cracks in interior walls which has a flexible or elastic membrane of uniform cross section that can be repeatedly stretched and released without rupturing.

U.S. Pat. No. 6,018,919 discloses a smooth wall finishing system which is a sheet material that covers the entire wall surface and bridges substrate irregularities by shrinking to a tight smooth surface. The material is made from a PVC compound formulated to meet code requirements.

There is still a need in the art for a system, method and/or material for providing a smooth finished surface to a rough or irregular wall surface. Moreover, a wallcovering is needed which provides a smooth finished surface for a rough or irregular wall surface in one installation step. Additionally, a wallcovering is desired which can shorten the time and reduce the cost required to finish an irregular wall surface, particularly such surfaces as unfinished gypsum wallboard, paneling or concrete. There is further a need in the art for a wallcovering which provides a smooth surface over a rough wall surface with a minimal increase in wall thickness. The present invention provides such a wallcovering.

### SUMMARY OF THE INVENTION

This invention is directed to a wallcovering system which provides a smooth, finished surface to irregular wall surfaces by means of a composite wallcovering material.

In one aspect of the invention, a wallcovering system designed to cover wall substrates with surface irregularities is provided comprising a composite wallcovering consisting essentially of a decorative wallcovering layer bonded to a base sheet having sufficient stiffness, thickness and compressibility to conceal surface irregularities and provide a substantially smooth wall surface. The base sheet in this aspect of the invention preferably comprises a nonwoven fiber glass mat. The decorative wallcovering layer preferably comprises a layer of woven glass fibers adhesively attached to the base sheet.

In another aspect of the invention, a composite wallcovering is provided comprising a wallcovering layer comprising a layer of woven glass fibers bonded to a base sheet comprising a nonwoven fiber glass mat. The wallcovering layer typically is adhesively bonded or attached to the base sheet.

In an additional aspect of the invention, a composite wallcovering is provided comprising a decorative wallcovering layer adhesively bonded to a base sheet having a bending stiffness of at least about 120 gcm (gram, centimeter) and a thickness of at least about 0.020 inches. In a preferred aspect, the base sheet additionally has a basis weight of at least about 3 lbs/100 ft².

In a further aspect of the invention, a method for providing a smooth finished surface on a wall substrate having a wall surface with surface irregularities is provided comprising applying an adhesive substantially uniformly to the wall surface and attaching to the wall surface a composite wallcovering consisting essentially of a decorative wallcovering layer bonded to a base sheet having sufficient stiffness, thickness and compressibility to conceal the surface irregularities. The result is a smooth finished surface on the wall substrate.

A method for providing a smooth finished surface to a wall substrate having a wall surface with surface irregularities is provided comprising applying an adhesive substantially uniformly to the wall surface, and attaching to the wall surface a composite wallcovering comprising a layer of woven glass fibers bonded to a nonwoven fiber glass mat.

### BRIEF DESCRIPTION OF THE DRAWINGS

FIG. 1 shows an example of the wallcovering system of the invention partially applied over a concrete block wall, showing the blocks, mortar joints, base sheet and decorative layer of the composite wallcovering.

FIG. 2 shows a detailed side view of a portion of a concrete block wall with an example of the wallcovering system of the invention applied, showing the blocks, mortar joints, wallcovering adhesive and the base sheet and decorative layer of the composite wallcovering.

### DETAILED DESCRIPTION OF THE INVENTION

This invention includes a wallcovering system whereby a rough or irregular wall surface is covered with a composite wallcovering having a decorative wallcovering layer bonded to a base sheet. Any wall surface or substrate may be covered with the composite wallcovering of the invention, but the composite wallcovering is particularly useful in providing a substantially smooth surface on irregular wall surfaces such as unfinished gypsum wallboard, paneling or concrete block walls.

“Irregular wall surface” or “rough wall surface” are used interchangeably and, as used herein, mean any surface with bumps, protrusions, gaps, voids, low spots or the like or any other surface condition or defect which results in or may result in a surface which is not substantially smooth. The irregular or rough wall surface may have defects due to damage or surface irregularities natural and expected in the type of material from which the wall surface or substrate is made, e.g. concrete block walls or paneling, or its method of manufacture. “Surface irregularities” as used herein means any bumps, protrusions, gaps, voids, low spots or the like or any other surface conditions or defects which result in or may result in a surface which is not substantially smooth. The surface irregularities may be due to damage to the wall surface or substrate or be due to the type of material from which the wall surface or substrate is made, or its method of manufacture.

The composite wallcovering system of the invention basically has a wallcovering layer and a base sheet. Additional layers may be included in the composite wallcovering provided the added layers do not increase the thickness of the wallcovering such that it is no longer acceptable or aesthetically pleasing, or prevent the base sheet from concealing surface irregularities by changing the characteristics of the base sheet when applied to the wall, or affect the ability of the composite wallcovering to be manufactured and delivered in a manner acceptable in the industry.

The base sheet material has a sufficient stiffness, thickness and compressibility to conceal surface irregularities on the wall surface of the wall substrate. Typically, the base sheet is stiff enough to bridge gaps, voids, low spots or other surface irregularities causing low spots or indentations in the underlying wall surface, sufficiently compressible in the out-of-plane direction so that surface irregularities sticking out of the wall surface (such as a nail head or a small piece of mortar) can press into the base sheet without the base sheet ‘bumping up’ over them, and of sufficient thickness that those irregularities protruding from the wall surface do not protrude through the base sheet.

The base sheet of the invention has sufficient stiffness, thickness and compressibility to conceal surface irregularities, surface roughness, surface indentations, surface bumps, and the like, which may be present on a wall substrate. The result after application of the composite wallcovering will be a substantially smooth wall surface on the wall substrate.

The stiffness of the base sheet will prevent the composite material from conforming to any gaps or low spots in the wall, thus contributing to a smooth surface. The base sheet typically will have sufficient stiffness if the bending stiffness is at least about 120 gcm. This may be determined by the Taber stiffness method as described in Technical Association of the Pulp and Paper Industry (TAPPI) method T489 om-92. This procedure measures the bending moment necessary to deflect the free end of a 38 mm wide vertically clamped specimen 15° from its center line when the load is applied 50 mm away from the clamp. All measurements described herein are adjusted by a multiplying factor of 2 after observing deflection to 7.5° as allowed in the standard method due to high stiffness of the materials. In one preferred aspect of the invention, the base sheet has a bending stiffness of between about 140 and about 180 gcm.

The thickness of the base sheet will be such that surface irregularities found on the wall surface of the wall substrate are concealed without having a sheet so thick that the composite wallcovering is too thick to provide a satisfactory wall surface or one that is not aesthetically pleasing. Generally, the base sheet will conceal out-of plane surface irregularities in the wall substrate such as nail and screw heads in gypsum wallboard surfaces and mortar and out-of plane blocks in concrete surfaces. In a preferred aspect of the invention, the base sheet will conceal surface irregularities up to about 0.125 inches (125 mils) thick.

The base sheet typically will have sufficient thickness to provide the desired effect in the composite wallcovering of the invention if the base sheet has a thickness of at least about 0.020 inches. In one preferred aspect of the invention, the thickness will be between about 0.065 and about 0.095 inches.

The base sheet desirably has a compressibility that, in conjunction with the thickness and stiffness, contributes to the ability of the composite wallcovering of the invention to conceal defects and irregularities in the wall substrate surface. The base sheet typically will have sufficient compressibility if the basis weight is at least about 3 lbs/100 ft². The basis weight of the sheet is measured in accordance with TAPPI method T410om-93. In this method the area of several sheets is determined by linear measurement and the mass is determined by weighing. The ratio of mass to area is reported as basis weight. In one preferred aspect of the invention, the basis weight of the base sheet will be between about 4.2 and about 4.8 lbs/100 ft².

The base sheet may be any material which provides sufficient stiffness, thickness, and compressibility to adequately cover the defects or irregularities of the wall surface to be covered and provides a substantially smooth wall surface. While each of these characteristics, stiffness, thickness and compressibility, are to be considered in determining an appropriate material for a base sheet, it is the overall result in the properties of the base sheet which determines that the base sheet has sufficient stiffness, thickness and compressibility to cover the surface irregularities of a wall surface or substrate.

Some materials which may be used for the base sheet include foam, fibrous, synthetic or cellulosic materials, or a combination thereof. It is believed that with these materials, the material should be both at least about 0.020 inches thick and have a bending stiffness of at least about 120 gcm in order to provide the overall properties of the base sheet of sufficient stiffness, thickness and compressibility. In a preferred aspect of the invention, the material is at least about 0.020 inches thick, has a bending stiffness of at least about 160 gcm and has a basis weight of at least about 3 lbs/100 ft².

Another material which may be used for the base sheet is a nonwoven fiber glass mat material. In one aspect of the invention, it has been discovered that where the base sheet is a nonwoven fiber glass mat, the desired characteristics of sufficient stiffness, thickness, and compressibility in the wallcovering composite can be obtained by use of a nonwoven fiber glass mat with a thickness of at least 0.020 inches, or basis weight of at least 3 lbs/100 ft², or bending stiffness of at least 120 gcm. Exemplary nonwoven mats which may be used as a base sheet are described in U.S. Pat. No. 5,840,413 and 5,942,288. One example of a satisfactory base sheet is a nonwoven fiber glass mat with a nominal thickness of 0.080 inches, basis weight of 4.5 lbs/100 ft² and nominal binder content of 16.5% by weight sold by Johns Manville as Dura-Glass® 5045W mat. Additional examples of nonwoven fiber glass mats which may be used as the base sheet in the composite wallcovering of the invention include Dura-Glasse® 8447 and Dura-Glasse® 8140.

Nonwoven fiber glass mats useful in the present invention typically will contain about 50 to about 90 weight percent fibers and about 8 to about 10 weight percent binder. In one aspect of the invention, the nonwoven glass fiber mats contain about 70 to about 90 weight percent fibers and about 10 to about 30 weight percent binder.

The majority of the fibers in the nonwoven fiber glass mats typically will be glass fibers. However, nonwoven fiber glass mats containing some minority portion of nonglass fibers such as man made or natural organic fibers like synthetic polymer fibers or fibers from cellulose derivatives may be used. Preferably, such nonwoven fiberglass mats will meet fire code requirements. Such nonwoven fiber glass mats are well known in the art.

The glass fibers which can be used to make nonwoven fiber glass mats useful in the composite wallcovering of the present invention may have various fiber diameters and lengths dependent on the strength and other properties desired in the mat. Typically glass fibers having average diameters from about 10 microns to about 20 microns can be used, but preferably from about 13 microns to about 17 microns are used. The fiber lengths of the glass fibers may be all about the same or different fiber lengths can be used. Typically, the length will be about ¾ to about 1 ¼ inch. The glass fibers can be E, C, T, S or any known type glass fiber of good strength and durability. Preferred fibers include E glass fibers.

Processes for making nonwoven fiber glass mats are well known and some of them are described in U.S. Pat. Nos. 4,112,174, 4,681,802 and 4,810,576, but any known method of making nonwoven mats may be used. Typical techniques for making nonwoven fiber glass mats involve forming a dilute aqueous slurry of fibers and depositing the slurry onto an inclined moving screen forming wire to dewater the slurry and form a wet nonwoven fibrous mat, on machines like a Hydroformer™ manufactured by Voith-Sulzer of Appleton, Wis., or a Deltaformer™ manufactured by Valmet/Sandy Hill of Glenns Falls, N.Y. Next, the wet, unbonded mat is transferred to a second moving screen running through a binder application saturating station where an aqueous binder is applied to the mat in any one of several known ways. The excess binder is removed and the wet mat is transferred to a wire mesh moving belt and passed through an oven to dry the wet mat and to cure (polymerize) the binder which bonds the fibers together in the mat. Preferably, the aqueous binder solution is applied using a curtain coater or a dip and squeeze applicator, but other known methods of application such as spraying will also work. Alternative forming methods for making the mat include the use of well known paper or board making processes such as cylinder forming, etc. or “dry laying” using carding or random fiber distribution.

The temperatures and times of drying and curing will depend on the binder selected for making the nonwoven fiber glass mat. Any number of binders are known in the art and methods for applying the various binders to form nonwoven fiber glass mats are also known in the art. In a preferred aspect of the invention, the binder is urea-formaldehyde, melamine formaldehyde or acrylic.

The wallcovering layer of the composite wallcovering may include any commercial or residential wallcovering material. Typically, the wallcovering layer will be a decorative wallcovering layer such as is known in the art. As used herein “decorative wallcovering layer” includes any material or layer which gives a wall surface a finished or completed look. In particular, a decorative wallcovering layer according to the invention will include any material used to create an aesthetically pleasing wall surface such that no further treatment of the wall surface is required. Such materials include glass textiles, vinyls, cellulose or vinyl/cellulose composites.

In a preferred aspect of the wallcovering composite, the wallcovering layer of the composite will be a layer of woven glass fibers. Typically, such a wallcovering layer will comprise glass fabric which is a woven product from fiberglass yarn. Many fiberglass yarns are possible for use in producing the woven material for use in the present invention. Such materials are known in the art, examples of which include Johns Manville Textra™ or Johns Manville Tassoglas™.

The decorative wallcovering layer typically is bonded to the base sheet by any means known to those of skill in the art. In one aspect of the invention, the decorative wallcovering layer is bonded by adhesive means to the base sheet. Such adhesive bonding includes the application of an adhesive to one or both materials to be bonded, lamination of the materials using an adhesive between the materials or other adhesive means known to those of skill in the art.

In one aspect of the invention, the decorative wallcovering layer is adhesively bonded or attached to the base sheet. The adhesive may be any suitable adhesive for bonding the materials selected for the base sheet and decorative wallcovering layer. In the aspect of the invention wherein the base sheet comprises nonwoven fiber glass mat and the decorative wallcovering layer comprises a layer of woven glass fibers, the adhesive typically will be a latex or water-borne adhesive that will result in the composite achieving a class A fire rating.

The decorative wallcovering layer may be adhesively bonded to the base sheet at a manufacturing facility and the composite product delivered in rolls to the job site in the same manner as typical wallcoverings. The system is then installed on the wall in the same manner as typical wallcovering products, with wallcovering adhesive. The stiffness of the base sheet will prevent the composite material from conforming to any gaps or low spots in the wall, thus providing a smooth surface. Applying the wallcovering adhesive substantially uniformly to the wall surface is beneficial in that the wall may be finished without first identifying any low spots.

The wallcovering system of the invention provides a smooth, finished surface to an irregular wall surface in a single installation step. This is a major advantage over known methods for providing a smooth surface on an irregular wall substrate. The wallcovering system of the invention allows for installation of the base sheet/wallcovering layer in a single step by adhering the composite material to the wall such that the base sheet provides the smooth surface and the wallcovering layer provides a finished wall surface.

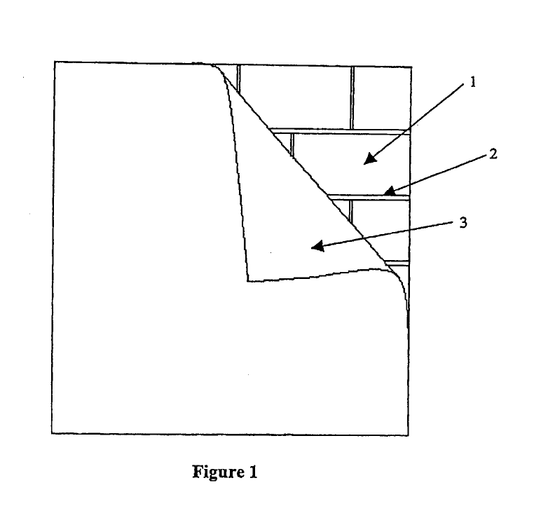

With regard to the examples of the invention shown in the figures, FIG. 1 illustrates an aspect of the wallcovering system of the invention wherein the composite wallcovering 3 is used to cover a wall surface 1 which has surface irregularities due to the construction of mortar joints in the wall substrate. The mortar joints 2 are covered by the composite wallcovering 3 to obtain a smooth finished wall.

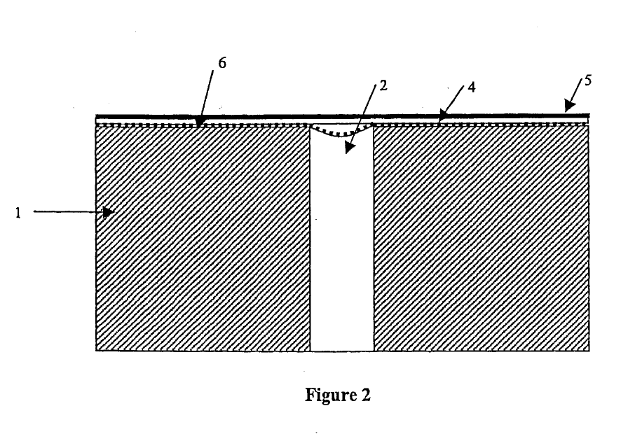

FIG. 2 illustrates an aspect of the wallcovering system of the invention, which aspect consists of a base sheet 4, bonded to a decorative wallcovering 5, to create a composite wallcovering system 3 that is attached to a wall surface 1, by means of a wallcovering or other type of adhesive 6. The adhesive 6 is applied substantially uniformly to the wall surface 1. The composite wallcovering 3 is installed onto wall surface 1 in a manner similar to typical wallcovering products. The base sheet 4 has a material stiffness sufficient that mortar joints 2 (in the case of a concrete block wall) and other surface irregularities or voids in the wall surface 1 are bridged by the composite wallcovering 3, thereby providing a smooth, finished wall surface in a single installation procedure.

In addition to concealing low spots and voids in a wall surface, this invention can also conceal small out-of-plane irregularities in the wall surface. These could include nail and screw heads in gypsum wallboard surfaces and mortar and out-of-plane blocks in concrete surfaces. The effectiveness of the composite wallcovering 3 in concealing these irregularities is determined in part by the compressibility and thickness of the base sheet 4. In a preferred aspect, the base sheet 4 can conceal surface irregularities of this type up to about 0.125 (⅛) inches thick.

One example of this invention, the base sheet 4 is a non-woven fiber glass mat with nominal thickness of 0.080 inches, basis weight of 4.5 lbs/100² and nominal binder content of 16.5% by weight (e.g., Johns Manville DuraGlass® 5045 mat) and the decorative wallcovering layer 3 is made of woven glass fibers, such as Johns Manville Textra™ or Johns Manville Tassoglas™. The two layers are adhesively bonded together at a manufacturing or laminating facility, and the composite product is then rolled and packaged as a single product. Further embodiments of the decorative wallcovering layer 3 could include any commercial or residential wallcovering material. Further embodiments of the base sheet 4 could include any non-woven fiber glass mat with thickness at least 0.020 inches, or basis weight of at least 3 lbs/100 ft² or bending stiffness of at least 120 gcm.

Additional embodiments could also include any foam, fibrous, synthetic or cellulosic material, or combination thereof or any nonwoven mat, that is at least 0.020 inches thick and has a bending stiffness of at least 120 gcm. Practical limits to these embodiments would likely, but not necessarily, be determined by the ability of the final composite material to be rolled and packaged for distribution.

This invention is intended to provide a smooth finished surface to a rough or irregular wall surface in one installation step. This system could considerably shorten the time and cost required to finish an irregular wall surface such as unfinished gypsum wallboard, paneling or concrete. Another benefit of this invention is to provide a smooth surface over a rough wall surface with an acceptable increase, or in preferred aspects, minimal increase, in wall thickness.

The present invention also provides methods for providing a smooth finished surface to a wall substrate having surface irregularities using the wallcovering systems described. In one aspect of the invention, a method for providing a smooth finished surface on a wall substrate having a wall surface with surface irregularities comprises applying adhesive substantially uniformly to the wall surface and attaching to the wall surface a composite wallcovering consisting essentially of a decorative wallcovering layer bonded to a base sheet having sufficient stiffness, thickness and compressibility to conceal the surface irregularities. The adhesive may be any of the adhesives known for use with the type of materials selected for the decorative wallcovering layer and the base sheet. In a preferred aspect of the method, the decorative wallcovering layer is a layer of woven glass fibers and the base sheet is a nonwoven fiber glass mat. Therefore, the adhesive in a preferred aspect of the method will be an adhesive which can adhere a nonwoven fiber glass mat to a wall surface. Such adhesives are known to those of skill in the art and include such adhesives as Heavy Duty Clear and Heavy Duty Clay. In a preferred aspect of the invention, Heavy Duty Clear is used when the base sheet is a nonwoven fiber glass mat.

The installation of the composite wallcovering by the method of the invention results in a smooth finished surface on the wall substrate. In addition, use of the composite wallcovering only requires one installation step to go from an unfinished, rough or irregular wall substrate or surface to a finished smooth wall surface.

While the preferred aspects of the invention have been disclosed in detail, it will be apparent to one skilled in the art that various changes and modifications can be made without departing from the spirit and scope thereof.

1. A wallcovering system designed to cover wall substrates with surface irregularities comprising a composite wallcovering consisting essentially of a decorative wallcovering layer bonded to a base sheet having sufficient stiffness, thickness and compressibility to conceal the surface irregularities and provide a substantially smooth wall surface on the wall substrate.

2. The wallcovering system of claim 1 wherein the decorative wallcovering layer comprises a layer of woven glass fibers.

3. The wallcovering system of claim 1 wherein the base sheet comprises a nonwoven fiber glass mat.

4. The wallcovering system of claim 1 wherein the base sheet has a bending stiffness of at least about 120 gcm.

5. The wallcovering system of claim 1 wherein the base sheet has a thickness of at least about 0.020 inches.

6. The wallcovering system of claim 1 wherein the base sheet has a basis weight of at least about 3 lbs/100 ft².

7. A composite wallcovering comprising a wallcovering layer comprising a layer of woven glass fibers adhesively bonded to a base sheet comprising a nonwoven fiber glass mat.

8. The composite wallcovering of claim 7 wherein the base sheet has a bending stiffness of at least about 120 gcm.

9. The composite wallcovering of claim 7 wherein the base sheet has a thickness of at least about 0.020 inches.

10. The composite wallcovering of claim 7 wherein the base sheet has a basis weight of at least about 3 lbs/100 ft².

11. The composite wallcovering of claim 7 wherein the base sheet has a bending stiffness of at least about 120 gcm, has a thickness of at least about 0.020 inches, and has a basis weight of at least about 3 lbs/100 ft².

12. A composite wallcovering comprising a decorative wallcovering layer adhesively bonded to a base sheet having a bending stiffness of at least about 120 gcm and a thickness of at least about 0.020 inches.

13. The composite wallcovering of claim 1 wherein the base sheet further has a basis weight of at least about 3 lbs/100 ft².

14. A method for providing a smooth finished surface to a wall substrate having a wall surface with surface irregularities comprising:
(a) applying an adhesive substantially uniformly to the wall surface and
(b) attaching to the wall surface a composite wallcovering consisting essentially of a decorative wallcovering layer bonded to a base sheet with sufficient stiffness, thickness and compressibility to conceal the surface irregularities and provide a smooth finished surface to the wall substrate.

15. The method of claim 14 wherein the decorative wallcovering layer is a layer of woven glass fibers.

16. The method of claim 14 wherein the base sheet is a nonwoven fiber glass mat.

17. The method of claim 14 wherein the base sheet has a bending stiffness of at least about 120 gcm.

18. The method of claim 14 wherein the base sheet has a thickness of at least about 0.020 inches.

19. The method of claim 14 wherein the base sheet has a basis weight of at least about 3 lbs/100 ft².

20. A method for providing a smooth finished surface to a wall substrate having a wall surface with surface irregularities comprising:
(a) applying an adhesive substantially uniformly to the wall surface, and
(b) attaching to the wall surface a composite wallcovering comprising a layer of woven glass fibers bonded to a nonwoven fiber glass mat.

21. The method of claim 20 wherein the layer of woven glass fibers is bonded to the nonwoven fiber glass mat by a latex or water borne adhesive that provides a composite wallcovering which achieves a class A fire rating.

22. The method of claim 20 wherein the nonwoven fiber glass mat has a bending stiffness of at least about 120 gcm, a thickness of at least about 0.020 inches and a basis weight of at least about 3 lbs/100 ft².
